(19) United States
(12) Patent Application Publication
(10) Pub. No.: US 2008/0090210 A1
(43) Pub. Date: Apr. 17, 2008

(54) Arrangement For Forming A Hole In A Jaw Bone, And Implant For Application In Said Hole

(76) Inventor: Izidor Brajnovic, Goteborg (SE)

Correspondence Address: KNOBBE MARTENS OLSON & BEAR LLP, 2040 MAIN STREET, FOURTEENTH FLOOR, IRVINE, CA, 92614, US

(21) Appl. No.: 11/587,876

(22) PCT Filed: Mar. 2, 2005
(86) PCT No.: PCT/SE05/00294

§ 371 Date: Sep. 26, 2007

(30) Foreign Application Priority Data
Apr. 29, 2004 (SE) 0401096-3

(51) Int. Cl. A61C 8/00; A61C 3/02

(52) U.S. Cl. 433/173; 433/165

(57) ABSTRACT

An arrangement for application or anchoring of an implant (17) in a jaw bone (8) by means of a hole formed in the jaw bone comprises a manually driven or machine-driven part which cooperates with the hole wall and which is designed to work with a hole wall cleaning function in order to form a surgically clean cut in the jaw bone. The implant can be arranged to be applied in the hole formed, and the implant is provided with one or more threads or thread parts which, when the implant is in the applied position, can be located opposite the cortical area or areas in the jaw bone. The implant is threads at the part or parts located opposite the spongy area or areas (11) of the jaw bone. By means of the invention, a surgically clean cut is obtained which, together with the design of the implant, contributes to accelerated osseointegration.

The present invention relates to an arrangement for application or anchoring of an implant in a jaw bone by means of a hole formed in the jaw bone. The invention also relates to an implant arrangement for application in the hole formed in the jaw bone.

It is already well known to anchor implants in holes formed in the jaw bone. In a normal procedure, the hole is formed using a drill, after which a generally self-tapping implant is screwed into the hole.

At the time such implants are applied, jaw bone residues remain on the hole walls and start up inflammation processes, which abate only after a defined period of time, which can be between 7 and 14 days. The implant design itself can also delay osseointegration, for example if the thread or threaded parts of the implant are located opposite the spongy area of the jaw bone and themselves therefore cause a tendency toward inflammation. The incorporation and anchoring process is therefore delayed by said period of time, during which great care has to be observed.

There is a need to be able to shorten the implantation time and ensure that osseointegration can start up and can proceed more quickly. The object of the present invention is to solve this problem among others.

The features which can principally be regarded as characterizing an arrangement according to the invention are that a manually driven or machine-driven part which cooperates with the hole wall is designed to work with a hole wall cleaning function so as to obtain, in the jaw bone, an at least substantially clean surgical cut free from jaw bone residues, blood, etc.

In further developments of the concept of the invention, it is proposed that, when performing the hole wall cleaning function, the part cooperating with the hole wall is designed to execute movements in both directions of rotation around the longitudinal axis during simultaneous displacement in the longitudinal direction of the hole. The part cooperating with the hole is designed to execute relatively short clockwise and counterclockwise movements during the longitudinal displacement. In a preferred embodiment, the part cooperating with the hole wall is a trephine drill with forwardly projecting points or tips and with cutting edges extending at and between these. The drill can then be secured in a manually activated handle part or in the drive part of a machine in a manner known per se.

The invention also relates to an implant designed to be applied in a hole whose hole wall has been cleaned, and the implant is provided with one or more threads or thread parts which, when the implant is in the applied position, are located substantially opposite the cortical area or areas of the jaw bone and are threadless on the part or parts which, in said position, are located substantially opposite the spongy area or areas of the jaw bone.

In one embodiment, the implant is provided completely or partially along its longitudinal direction with one or more porous surface layers, for example of the TiUnite™ type, included in dental products sold by the Applicant filing the present patent application. The implant can be provided with a short thread which is arranged directly under its head or top part and which extends 8-16%, preferably ca. 12%, of the implant length and can cooperate with the outer cortical area of the jaw bone. Further characteristics of the implant are set out in the dependent claims.

By means of what has been proposed above, substantially clean surgical cuts can be obtained in the holes formed in the jaw bone and these permit more rapid osseointegration. Tools or instrument parts known per se can be used when a trephine drill is employed. It is a characteristic of the invention that the drill is to be given short movements in the counterclockwise and clockwise directions. In a hole cleaned in this way, the implant of the type mentioned is applied so that spongy areas in the jaw bone are prevented from interacting with threads on the implant and thus counteracting said self-cleaning function.

A presently proposed embodiment of an arrangement having the features characteristic of the invention will be described below with reference to the attached drawings, in which:

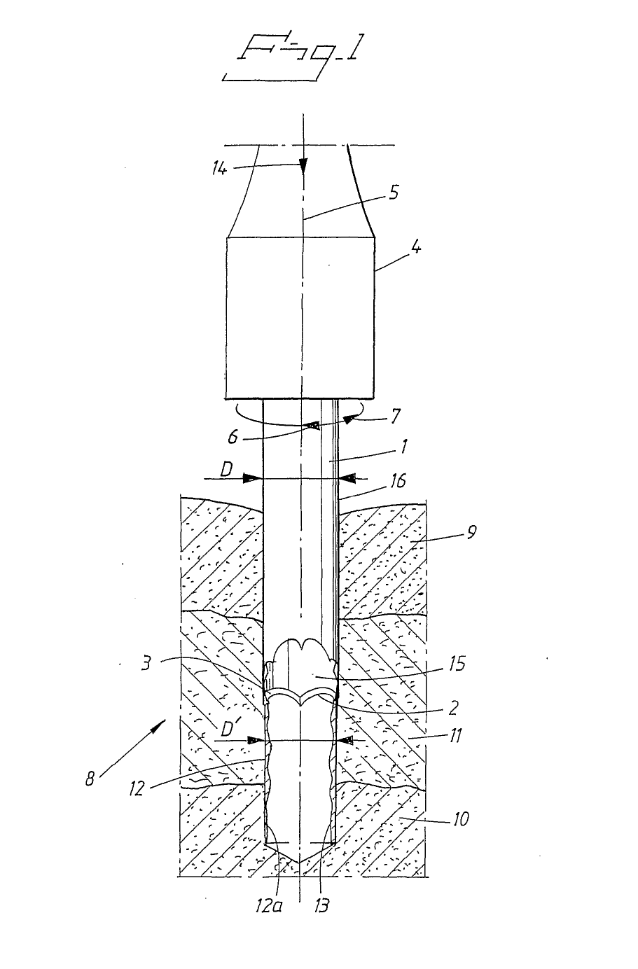

FIG. 1 is a vertical section showing a drill which performs a cleaning function and which is longitudinally displaced down into a hole formed in a jaw bone, some of the cortical and spongy areas of the jaw bone being shown symbolically,

FIG. 2 is a vertical view showing the application of an implant into the hole thus cleaned in a jaw bone,

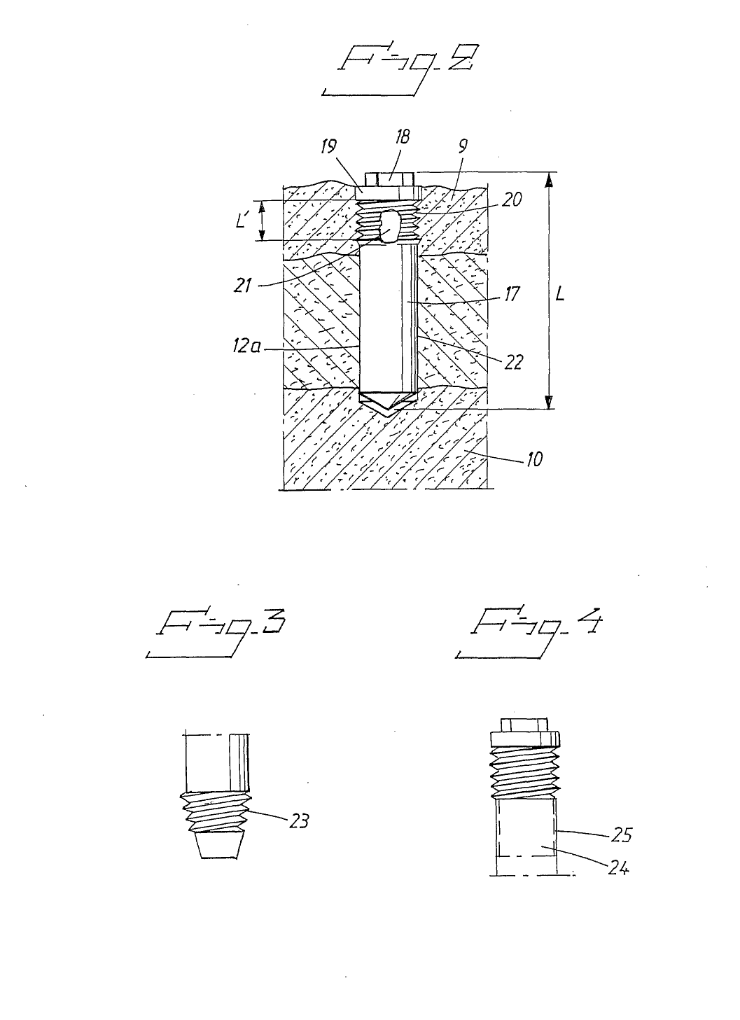

FIG. 3 is a vertical section showing part of an implant in an embodiment which is different than the embodiment according to FIG. 2 in that its lower part too is provided with a thread or thread part which can cooperate with an inner cortical area in the jaw bone, and

FIG. 4 is a vertical view showing the implant according to FIG. 2, where the part or parts under an upper thread or thread part is/are provided with a porous surface layer designed to accelerate the process of incorporation.

In FIG. 1, a trephine drill is designated by reference number 1. At its lower or front parts, the drill is provided with forwardly projecting points or tips 2 between which cutting edges 3 are arranged. The drill can be fitted to an attachment part 4 of a handle for manual actuation of the drill or to a drive part for driving the drill. The attachment means can be configured in a manner known per se, and handle parts and drive instruments of a known type can be used and will therefore not be described in any more detail here. A characteristic of its operation is that the drill is to be able to be given rotation movements about a longitudinal axis 5 for the drive part and the drill. The drill must be able to be actuated in the clockwise and counterclockwise directions, which have been indicated by arrows 6 and 7 in FIG. 1. FIG. 1 also shows a jaw bone 8 symbolically, and also the latter's cortical outer and inner areas 9 and 10, respectively. The jaw bone also includes a spongy area 11. A hole 12 has been formed in the jaw bone. This hole can be configured in a manner known per se and using drills known per se, and it will therefore not be described in any more detail here. The drill 1 shown in FIG. 1 performs a cleaning function. When the hole 12 is normally being formed in the jaw bone 8, residues of jaw bone, blood, plasma, etc, gather in the hole, as has been symbolized by 13 in FIG. 1. In accordance with the concept of the invention, it is recommended to clean these residues 13 away so that a surgically clean cut is obtained. The points 2 and the cutting edges 3 lying between them on the drill 1 are designed to provide said cleaning function. Said cleaning function is effectively obtained by giving the drill 1 short rotation movements in the clockwise and counter-clockwise directions 6 and 7 and at the same time acting on the drill 1 in the direction of longitudinal displacement 14. The residues 13 are able to penetrate into the inside 15 of the tubular drill, and the plane and uniformly thick outer surface 16 of the drill seals off the inner wall of the hole 12 or its inner surface 12a. The external diameter D of the drill will thus substantially or slightly exceed the diameter D′ of the hole. The short rotation movements in the clockwise and counterclockwise directions can be of an order of magnitude corresponding, for example, to 10-45° of the circumference of the drill 1. The drill thus removes the residues 13 and levels or substantially flattens the wall surface 12a.

Immediately after or almost at the same time as this cleaning function in the hole, an implant 17 is applied in accordance with FIG. 2. The implant can be provided in a manner known per se with a screw-in part 18 and a top part 19 constituting an attachment for a prosthesis (not shown in FIG. 2). The present implant is of the type comprising a short thread part 20 which extends under said top part 19. In FIG. 2, the length of the implant has been indicated by L, and the length of the thread has been indicated by L′. The threaded part 20 must be able to be located at least substantially opposite the upper cortical area 9 (see also FIG. 1). In one illustrative embodiment, the length L′ of the thread extends ca. 8-16%, preferably ca. 12%, of the length L of the implant. The implant thread is provided with a recess 21 along its circumference. The number of such recesses can vary and, in one illustrative embodiment, there is a uniform distribution of the recesses in the case of a plurality of recesses. The outer surface 22 of the implant also presses against the hole wall 12a.

In accordance with FIG. 3, the implant can be provided, at its front or lower end, with another short thread 23 which can cooperate with the inner cortical area 10. The thread 23 can then in principle be given a smaller diameter than the diameter for the hole at the threadless part.

In accordance with FIG. 4, the implant can be provided, at its threadless part or its threadless parts 24, with one or more surface layers 25 which are of a porous nature and which, for example, go under the designation TiUnite on the Applicant's products that are available on the market.

Said forwardly projecting points or tips, and the cutting edges arranged at these, can be of a type known per se and characteristic of drill types of the type in question here. The points and the cutting edges will therefore not be described in any detail here.

The invention is not limited to the embodiment described above by way of example, and instead it can be modified within the scope of the attached patent claims and the inventive concept.

1. An arrangement for use in dental surgery comprising a drill having a at least one cutting edge configured to cooperate to obtain, in a hole of a jaw bone, an at least substantially clean surgical cut.

2. The arrangement as in claim 1, wherein, when performing the hole wall cleaning function, the at least one cutting edge is designed to execute movements in both directions of rotation around the longitudinal axis during simultaneous displacement in the longitudinal direction of the hole.

3. The arrangement as in claim 2, wherein the cutting edge cooperating with the hole wall is designed to execute relatively short clockwise and counterclockwise movements during the longitudinal displacement.

4. The arrangement as claimed in claim 1, wherein the part cooperating with the hole wall is a trephine drill with forwardly projecting points or tips and with cutting edges extending at and between these.

5. The arrangement as in claim 4, wherein that the drill is secured in a manually activated handle part or in the drive part of a machine.

6. A method of implanting a dental implant in a hole formed in a jaw bone, comprising: cleaning a hole formed in a jaw bone, inserting the implant in the hole whose hole wall has been cleaned, and in that the implant is provided with one or more threads or thread parts which, when the implant is in the applied position, are located substantially opposite the cortical areas of the jaw bone and are threadless on the part or parts which, in said position, are located substantially opposite the spongy area or areas of the jaw bone.

7. The method as in claim 6, wherein the implant is provided, completely or partially along its longitudinal direction, with one or more porous surface layers, for example of the TiUnite™ type.

8. The method as claimed in claim 6 wherein the implant is provided with a short thread which is arranged directly under its head or top part and which extends 8-16%, preferably ca. 12%, of the implant length and can cooperate with the outer cortical area of the jaw bone.

9. The method as in claim 6, wherein the thread (20) is provided with one or more recesses arranged along its circumference.

10. The method as in patent claim 6, wherein the implant is provided at its inner end with a thread which can cooperate with the inner cortical or hard area of the jaw bone and/or in that the threadless part has a porous layer.
